(19) United States
(12) Patent Application Publication
(10) Pub. No.: US 2025/0265473 A1
(43) Pub. Date: Aug. 21, 2025

(54) FINE-TUNING APPARATUS AND METHOD FOR NEURAL ARCHITECTURE SEARCH

(71) Applicant: Korea University Research and Business Foundation, Seoul (KR)

(72) Inventors: Joongheon KIM, Seoul (KR); Seokbin SON, Seoul (KR); SooHyun PARK, Incheon (KR); Younkyu LEE, Seoul (KR); Soyi JUNG, Seoul (KR)

(21) Appl. No.: 18/990,540

(22) Filed: Dec. 20, 2024

(30) Foreign Application Priority Data
Feb. 15, 2024 (KR) 10-2024-0022142

(51) Int. Cl. G06N 3/092

(52) U.S. Cl. CPC G06N 3/092

(57) ABSTRACT

The present disclosure relates to a fine-tuning apparatus for neural architecture search (NAS), the apparatus including an architecture fine-tuning unit that samples candidate architectures for target data from a search space having a plurality of SubNets and searches for an optimal architecture for the target data based on the candidate architectures; and a weight fine-tuning unit that tunes a pre-trained weight of the optimal architecture to match the target data.

### CROSS-REFERENCE TO RELATED APPLICATIONS

This application claims priority under 35 U.S.C § 119 to Korean Patent Application No. 10-2024-0022142 filed in the Korean Intellectual Property Office on Feb. 15, 2024, the entire contents of which are hereby incorporated by reference.

### BACKGROUND OF THE INVENTION

### Field of the Invention

The present disclosure relates to a fine-tuning apparatus and method for neural architecture search (NAS).

This research was carried out with research funding support from the Basic Research Laboratory Support Program (2021R1A4A1030775) of the National Research Foundation of Korea.

### Background of the Related Art

In general, a neural network (NN) is trained with a large amount of data to learn specific knowledge, and its performance depends on the quality and statistical distribution of the data. The data-driven nature of the NN hinders the practical application of computer vision operations in various industries due to data shortage, and even when a sufficient amount of data is collected, manual labeling may require additional costs. As a result, the lack of labeled data reduces the image processing capability of the NN in research fields.

Therefore, in recent years, the concept of transfer learning has emerged to address the foregoing problem and has been applied to various fields and applications. Transfer learning is the use of pre-trained knowledge about source data to perform similar operations on target data, and among various transfer learning methodologies, fine-tuning is a method of tuning a pre-trained NN to match target data so as to achieve better performance with a sufficient number of data items.

Meanwhile, in the field of deep learning research, research on neural architecture search (NAS) as an automated methodology for finding the architecture of a deep learning model is actively underway. NAS has an advantage of being able to find an optimal neural network structure without human intervention, thereby saving time and effort and improving performance.

However, despite such an advantage, it is not easy to apply NAS to actual operations due to the enormous computational and search time.

### CITATION LIST

### Patent Literature

(Patent Document 1) Korean Patent No. 10-2232138

### SUMMARY OF THE INVENTION

An aspect of the present disclosure is contrived to solve the foregoing problems, and an aspect of the present disclosure is to provide a fine-tuning apparatus and method for NAS.

In order to achieve the foregoing objective, a fine-tuning apparatus for neural architecture search (NAS) according to an embodiment of the present disclosure may include an architecture fine-tuning unit that samples candidate architectures for target data from a search space having a plurality of SubNets and searches for an optimal architecture for the target data based on the candidate architectures; and a weight fine-tuning unit that tunes a pre-trained weight of the optimal architecture to match the target data.

In order to achieve the foregoing objective, a fine-tuning method for neural architecture search (NAS) according to an embodiment of the present disclosure may include an architecture fine-tuning stage of sampling candidate architectures for target data from a search space having a plurality of SubNets, and searching for an optimal architecture for the target data based on the candidate architectures; and a weight fine-tuning stage of tuning a pre-trained weight of the optimal architecture to match the target data.

According to one aspect of the present disclosure described above, a fine-tuning apparatus and method for NAS may be provided, thereby extending the practical use of transfer learning to fields where the application of neural network models has been difficult due to lack of data. In addition, the apparatus and method of the present disclosure may search for a better neural network model and reduce search time and resultant cost.

### BRIEF DESCRIPTION OF THE DRAWINGS

FIG. 1 is a conceptual diagram of a fine-tuning apparatus according to an embodiment of the present disclosure.

FIG. 2 is an apparatus diagram illustrating internal blocks of a fine-tuning apparatus according to an embodiment of the present disclosure.

FIG. 3 is an apparatus diagram illustrating a detailed configuration of an architecture fine-tuning unit in FIG. 2.

FIG. 4 is a drawing for explaining an overall operation for two-staged fine-tuning in a fine-tuning apparatus according to an embodiment of the present disclosure.

FIG. 5 is a drawing for explaining a search space constructed in a SubNet sampler in FIG. 3.

FIG. 6 is a drawing for explaining an operation of a weight fine-tuning unit in FIG. 2.

Furthermore, FIG. 7 is a flowchart showing an a fine-tuning process of a fine-tuning apparatus according to an embodiment of the present disclosure.

### DETAILED DESCRIPTION OF THE PREFERRED EMBODIMENT

The detailed description of the present disclosure described below refers to the accompanying drawings, which show, by way of illustration, specific embodiments to carry out the present disclosure. These embodiments are described in sufficient detail to enable those skilled in the art to carry out the present disclosure. It should be understood that various embodiments of the present disclosure are different from one another but are not necessarily mutually exclusive. For example, specific shapes, structures and characteristics described herein may be implemented in other embodiments without departing from the concept and scope of the present disclosure in connection with one embodiment. In addition, it should be understood that the locations or arrangement of individual elements within each disclosed embodiment may be changed without departing from the concept and scope of the present disclosure. Therefore, the following detailed description is not to be taken in a limiting sense, and the scope of the present disclosure is defined only by the appended claims along with the entire scope of equivalents thereof, if properly described. The similar reference numerals refer to the same or similar functions in various aspects.

Elements according to the present disclosure may be elements that are defined not by physical properties but by functional properties, and thus each element may be defined by its function. Each element may be implemented as hardware and/or a program code and a processing unit for performing a function thereof, and functions of two or more elements may also be included and implemented in a single element. Accordingly, it should be noted that names of elements in embodiments to be described below are given to imply representative functions performed by each of the elements rather than to physically distinguish each of the elements, and the technical spirit of the present disclosure is not limited by the names of the elements.

Hereinafter, preferred embodiments of the present disclosure will be described in more detail with reference to the drawings.

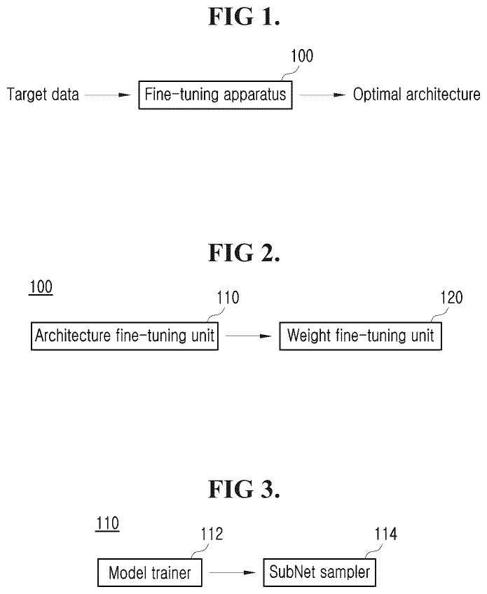

FIG. 1 is a conceptual diagram of a fine-tuning apparatus according to an embodiment of the present disclosure.

The illustrated fine-tuning apparatus 100 searches for and outputs, when target data is input, an optimal architecture for the target data. A detailed operation for outputting the optimal architecture of the fine-tuning apparatus 100 will be described in detail below.

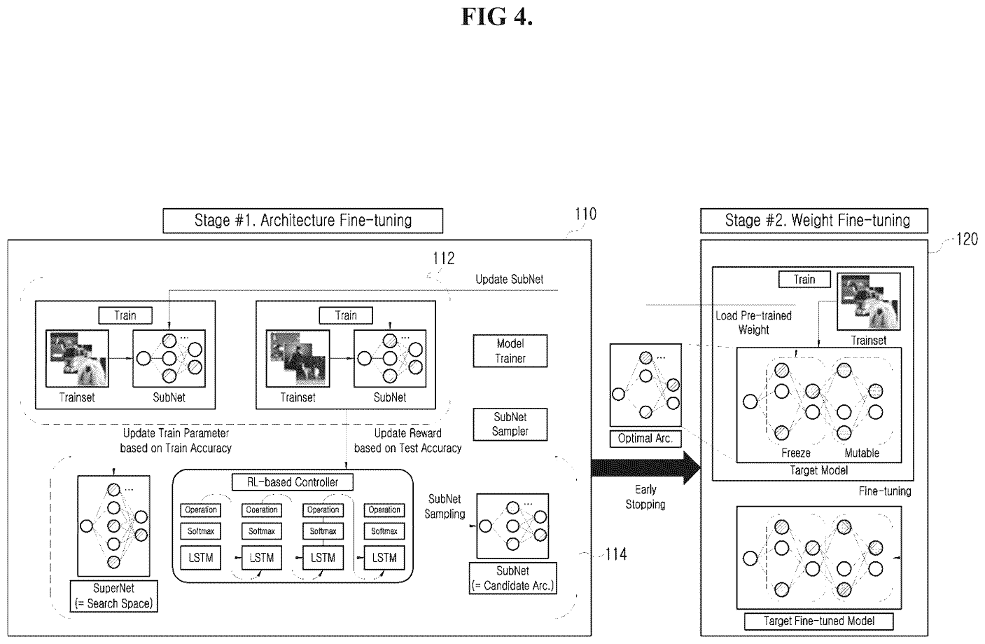

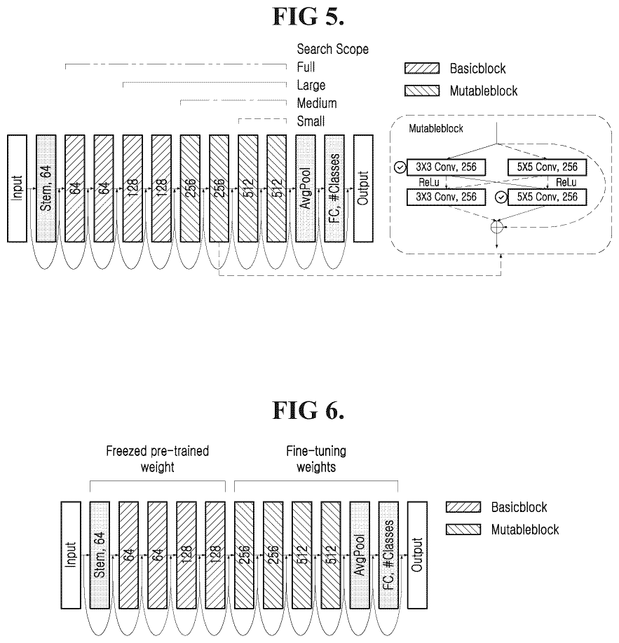

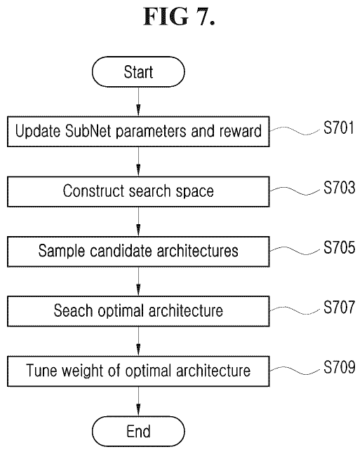

FIG. 2 is an apparatus diagram illustrating internal blocks of a fine-tuning apparatus according to an embodiment of the present disclosure, FIG. 3 is an apparatus diagram illustrating a detailed configuration of an architecture fine-tuning unit in FIG. 2, FIG. 4 is a drawing for explaining an overall operation for two-staged fine-tuning in a fine-tuning apparatus according to an embodiment of the present disclosure, FIG. 5 is a drawing for explaining a search space constructed in a SubNet sampler in FIG. 3, and FIG. 6 is a drawing for explaining an operation of a weight fine-tuning unit in FIG. 2.

The fine-tuning apparatus 100 illustrated in FIG. 2 includes an architecture fine-tuning unit 110 and a weight fine-tuning unit 120, and the architecture fine-tuning unit 110 is configured with a model trainer 112 and a SubNet sampler 114 as shown in FIG. 3.

The architecture fine-tuning unit 110 samples candidate architectures for target data from a search space having a plurality of SubNets, and searches for an optimal architecture for the target data based on the candidate architectures.

More specifically describing an optimal architecture search operation of the architecture fine-tuning unit 110 through the detailed components, first, the model trainer 112 learns a train set (Trainset) to update the parameters of a SubNet, and tests the updated SubNet through a test set (Testset) to update a reward based on accuracy.

Then, the SubNet sampler 114 constructs a search space having a plurality of SubNets using parameters fed back from the model trainer 112. Here, the SubNet may be a basic block or a mutable block that extends a kernel size of the basic block. In addition, the search space may be defined as all available candidate architectures represented by Sᵢ [symbol] {s₁, . . . , s_{N}_{ᵢ}}, that is, a set of N SubNets. The larger the search space, the more likely it is to contain an optimal architecture, but a large search space requires a high cost (e.g., computing resources and time) to search for an optimal architecture, which reduces search performance. Therefore, in an embodiment of the present disclosure, a search space including a mutable block is proposed as shown in FIG. 5. The search space includes a basic block that serves as a starting point for architecture search and a mutable block designed according to a layer-level mutation rule.

In an embodiment of the present disclosure, ResNet-18, which is relatively lightweight and shows excellent performance for an image classification operation of ImageNet, was selected as a basic block, that is, a basic architecture, and since a layer operation is a minimum configuration unit of a NN, a layer-level approach method may be applicable to various basic architectures.

A mutation rule that can replace a kernel size of each 3×3 convolutional layer of the basic block of ResNet-18 with 5×5 is designed. Taking into account various sizes of each kernel, the receptive fields vary, which affects the performance of a convolutional neural network (CNN). A mutable block is a logical unit block for applying a mutation rule to a basic block in terms of implementation, and such a mutable block is activated by the SubNet sampler 114 and transformed into an executable type in a deep learning framework.

In this manner, the SubNet sampler 114 constructs a search space using parameters fed back from the model trainer 112, and at this time, the search space is constructed according to a level selected from among predefined search scope levels. The search scope levels may be defined as four levels, for example, a small level, a medium level, a large level, and a full level, as shown in FIG. 5. At the end of an architecture given based on the knowledge that a shallow layer of an NN extracts general features, the search scope levels are gradually extended, which helps in transfer learning.

The mutation rule transforms a basic block within the search scope into a mutable block to construct a SuperNet, and the parameters of a SubNet updated by the training of the model trainer 112 are reflected in the SuperNet and reused for training other SubNets. In the case of a medium level using ResNet-18, the last four basic blocks are included in the search scope, and the remaining blocks are set to be invariant for both architecture and parameters during fine-tuning. Table 1 below shows a total number of candidate architectures to search for due to the base architecture and search scope.

TABLE 1

| Search scope | ENASResNet-18 | ENASResNet-50 |
|---|---|---|
| (Small, medium, large, full) | (2⁴, 2⁸, 2¹², 2¹⁶) | (2³, 2⁹, 2¹³, 2¹⁶) |

In addition, the SubNet sampler 114 samples candidate architectures for target data from the search space using rewards fed back from the model trainer 112.

More specifically, the SubNet sampler 114 may include a Softmax classifier and a long short-term memory (LSTM) cell that predicts the selection for each mutable layer operation through an embedding layer, as shown in FIG. 4. Therefore, the SubNet sampler 114 fetches a previous state-action history τₜ₋₁ and then returns an action and a current state-action history τₜ. That is, it follows that aₜ=arg maxₐ π_{θ}(aₜ|τₜ₋₁), ∀ aₜ∈{0,1} and τₜ=LSTM_{θ}(τₜ₋₁), and π_{θ}(aₜ|τₜ₋₁)=Softmax(FC(LSTM(τₜ₋₁))) Here, π_{θ} represents a parameterized controller, LSTM represents an LSTM model, Softmax represents a Softmax activation function, and FC represents a fully connected layer.

The goal is to maximize expected discounted returns, and Gᵢ= [symbol] [Σₜ₌ᵢ^{┌log}^{₂} ^{N┐}γⁱ⁻¹. r(τᵢ₋₁, aᵢ)·π_{θ}(aᵢ|τᵢ₋₁)]. Here, γ is a discount factor, and the reward function r(τₜ₋₁, aₜ) is computed based on the test accuracy of the sampled candidate architectures, i.e., SubNets. τ₀ is the same as an initial state, and a reinforcement learning method is used to maximize a discounted cumulative reward G₁. That is, J(θ)=Σₜ₌₁^{┌log}^{₂} ^{N┐}[log π_{θ}(aₜ|τₜ₋₁)·Gₜ].

The SubNet sampler 114 updates a control unit parameter set 0 and then samples an action set A={a₁, . . . , a_{┌log}_{₂} _{N┐}}. That is, a SubNet is sampled by selecting each convolution operation for a mutable layer corresponding to an action set A, and the SubNet is trained on a training set through a stochastic gradient descent (SGD) of a cross entropy function. At this time, the parameters of the SubNet are fully synchronized with a SuperNet.

Finally, the SubNet sampler 114 searches for an optimal architecture for target data from the sampled candidate architectures based on reinforcement learning (RL). At this time, the SubNet sampler 114 may early stop the search for the optimal architecture based on a total reward and an action distribution fed back from the model trainer 112.

Next, the weight fine-tuning unit 120 tunes a pre-trained weight of the optimal architecture searched for through the architecture fine-tuning unit 110 to match the target data. More specifically describing with reference to FIG. 6, the weight fine-tuning unit 120 freezes a pre-trained weight in a layer that is not included in a search scope in the searched optimal architecture to utilize general knowledge of source data, and fine-tunes the pre-trained weight in a layer that is included in the search scope through re-learning for target data to learn data-specific features. At this time, only the learnable weight parameters within the relearning scope are fine-tuned, and the architecture parameters are not modified at this stage.

FIG. 7 is a flowchart showing a fine-tuning process of a fine-tuning apparatus according to an embodiment of the present disclosure.

The architecture fine-tuning unit of the fine-tuning apparatus according to an embodiment of the present disclosure updates the parameters and reward of the SubNet (S701) Then, the architecture fine-tuning unit constructs a search space using the parameters updated in S701 (S703).

In addition, the architecture fine-tuning unit samples candidate architectures for target data from the search space using the reward updated in S701 through the SubNet sampler (S705).

Then, the architecture fine-tuning unit searches for an optimal architecture from the candidate architectures sampled in S705 based on reinforcement learning (S707).

Then, the weight fine-tuning unit tunes a pre-trained weight of the optimal architecture searched for in S707 to match the target data (S709).

The fine-tuning method according to an embodiment of the present disclosure is performed in two stages: an architecture fine-tuning stage and a weight fine-tuning stage, and S701 to S707 described above are included in the architecture fine-tuning stage, and S709 is included in the weight fine-tuning stage.

The foregoing fine-tuning method for NAS of the present disclosure may be implemented in the form of program instructions that can be executed through various computer elements and recorded on a computer-readable recording medium. The computer-readable recording medium may include program instructions, data files, data structures, and the like separately or in combination.

The program instructions stored on the computer-readable recording medium may be specially designed and configured for the present disclosure, or may also be known and available to those skilled in the computer software field.

Examples of the computer-readable recording medium include magnetic media such as hard disks, floppy disks, and magnetic tapes, optical media such as compact disk-read only memory (CD-ROM) and digital versatile disks (DVDs), magneto-optical media such as floptical disks, and hardware devices such as read-only memory (ROM), random access memory (RAM), and flash memory, which are specially configured to store and execute program instructions.

Examples of the program instructions include not only machine language codes created by a compiler or the like, but also high-level language codes that can be executed by a computer using an interpreter or the like. The hardware devices may be configured to operate as one or more software modules in order to perform the operation of the present disclosure, and vice versa.

While various embodiments of the present disclosure have been shown and described above, it will be of course understood by those skilled in the art that various modifications may be made without departing from the gist of the disclosure as defined in the following claims, and it is to be noted that those modifications should not be understood individually from the technical concept and prospect of the present disclosure.

### DESCRIPTION OF SYMBOLS

100: Fine-tuning apparatus
110: Architecture fine-tuning unit
112: Model trainer
114: SubNet sampler
120: Weight fine-tuning unit

What is claimed is:

1. A fine-tuning apparatus for neural architecture search (NAS), the apparatus comprising:
an architecture fine-tuning circuit configured to sample candidate architectures for target data from a search space having a plurality of SubNets, and configured to search for an optimal architecture for the target data based on the candidate architectures; and
a weight fine-tuning circuit configured to tune a pre-trained weight of the optimal architecture to match the target data.

2. The apparatus of claim 1, wherein the architecture fine-tuning circuit comprises a model trainer configured to learn a train set (Trainset) to update parameters of at least one SubNet in the plurality of subnets, and configured to test the updated at least one SubNet through a test set (Testset) to update a reward based on accuracy.

3. The apparatus of claim 2, wherein the architecture fine-tuning circuit further comprises a SubNet sampler configured to sample the candidate architectures using a reward fed back from the model trainer, and configured to search for the optimal architecture from the candidate architectures utilizing reinforcement learning (RL).

4. The apparatus of claim 3, wherein the SubNet sampler is configured to construct the search space using parameters fed back from the model trainer, wherein the search space is constructed according to a level selected from among predefined search scope levels.

5. The apparatus of claim 3, wherein the SubNet sampler is configured to stop the search for the optimal architecture early based on a total reward and an action distribution fed back from the model trainer.

6. The apparatus of claim 1, wherein the at least one SubNet is a basic block or a mutable block that extends a kernel size of the basic block.

7. The apparatus of claim 1, wherein the weight fine-tuning circuit is configured to freeze a pre-trained weight in a layer outside a search scope of the optimal architecture, and configured to fine-tune the pre-trained weight in a layer inside the search scope.

8. A fine-tuning method for neural architecture search (NAS), the method comprising:
executing an architecture fine-tuning stage, comprising sampling candidate architectures for target data from a search space having a plurality of SubNets, and searching for an optimal architecture for the target data based on the candidate architectures; and
executing a weight fine-tuning stage, comprising tuning a pre-trained weight of the optimal architecture to match the target data.

9. The method of claim 8, wherein the architecture fine-tuning stage comprises learning a train set (Trainset) and updating parameters of at least one SubNet in the plurality of Subnets, and testing the updated at least one SubNet through a test set (Testset) to update a reward based on accuracy.

10. The method of claim 9, wherein the architecture fine-tuning stage comprises sampling the candidate architectures using the reward, and searching for the optimal architecture from the candidate architectures based on reinforcement learning (RL).

11. The method of claim 10, wherein the architecture fine-tuning stage comprises constructing the search space using the parameters, wherein the search space is constructed according to a level selected from among predefined search scope levels.

12. The method of claim 10, wherein the search for the optimal architecture is stopped early based on a total reward and an action distribution.

13. The method of claim 8, wherein the at least one SubNet is a basic block or a mutable block that extends a kernel size of the basic block.

14. The method of claim 8, wherein the weight fine-tuning stage comprises freezing a pre-trained weight in a layer outside a search scope of the optimal architecture, and fine-tuning the pre-trained weight in a layer inside the search scope.
